(19) United States
(12) Patent Application Publication
(10) Pub. No.: US 2006/0036010 A1
(43) Pub. Date: Feb. 16, 2006

(54) Resin composition comprising styrene-methylmethacrylate copolymer, artificial marble produced using the same, and the process for producing the artificial marble using the same

(76) Inventors: Hang-Young Kim, Daejeon (KR); Min-Chul Sung, Seoul (KR)

Correspondence Address: CANTOR COLBURN, LLP, 55 GRIFFIN ROAD SOUTH, BLOOMFIELD, CT, 06002, US

(21) Appl. No.: 11/087,480

(22) Filed: Mar. 23, 2005

(30) Foreign Application Priority Data
Aug. 12, 2004 (KR) 10-2004-0063450

(51) Int. Cl. C04B 26/06

(52) U.S. Cl. 524/437; 524/556; 525/244

(57) ABSTRACT

Provided are a resin composition, comprising 100 parts by weight of a styrene-methylmethacrylate resin solution containing a styrene-methylmethacrylate copolymer and at least one of styrene and methylmethacrylate; 100 to 200 parts by weight of an inorganic filler; and 0.5 to 10 parts by weight of a cross-linkable monomer; and an artificial marble prepared using the same and a process for preparing the same. The resin composition can provide an artificial marble having improved transparency due to reduction of refractive index difference between aluminum hydroxide and methylmethacrylate while maintaining excellent weatherability and thermal characteristics possessed by a conventional acrylic polymer.

### BACKGROUND OF THE INVENTION

1. Field of the Invention

The present invention relates to a resin composition comprising a styrene-methylmethacrylate copolymer, an artificial marble prepared using the same, and a process for preparing the artificial marble using the same. More particularly, the present invention relates to an artificial marble having improved transparency wherein a methylmethacrylate monomer (refractive index 1.49) and a highly refractive styrene monomer (refractive index 1.59) are co-polymerized to obtain a styrene-methylmethacrylate which is then used to reduce the refractive index difference between an aluminum hydroxide and methylmethacrylate, thus solving problems associated with decreased transparency due to refractive index difference between the methylmethacrylate and aluminum hydroxide (refractive index 1.57 to 1.60) which is used as a filler, when a conventional methylmethacrylate and polymer thereof are used alone in preparing the artificial marble.

2. Description of the Related Art

The term “Artificial marble” commonly refers to artificial synthetics that have realized texture of natural stones by compounding natural stone powder or minerals with resin components (such as acrylics, unsaturated polyesters, epoxies and the like) or cement and adding various pigments and additives thereto. As representative examples of such artificial marbles, mention may be made of acrylic artificial marble and polyester based artificial marble. These acrylic artificial marble and polyester based artificial marble exhibit strength and the color tone unique to solid materials. In particular, the acrylic artificial marble has excellent processability and weatherability. In addition, the acrylic artificial marble is relatively light-weight and non-porous compared to natural marbles, and has elegant color tone, excellent strength and weatherability comparable to natural marbles. Further, the acrylic artificial marble has superior processability comparable to lignum and thus may be distinctive from natural marbles.

Meanwhile, the polyester based artificial marble has disadvantages such as relatively poor weatherability and heat resistance compared to the acrylic artificial marble, and difficulty in thermoforming thereof. However, the polyester based artificial marble also has advantages such as excellent transparency of the polymerized product due to a refractive index similar to that of aluminum hydroxide used as the filler, and thus is capable of realizing natural and deep appearance as exhibited in natural stones. Such artificial marbles have recently used for a variety of applications such as deck plate materials, dressing tables, rinsing lavatory units, tables, wall materials, flooring materials, furniture, interior finish, indirect illumination panels and interior pieces.

Japanese Patent Laid-open No. 2002-105144 discloses a polyester based artificial marble to which a methylmethacrylate monomer was added to obtain an excellent weatherability effect of the acrylic artificial marble. Such an artificial marble, however, suffers from problems associated with increased volatile components and decreased compound viscosity, upon addition of the monomer, and effects obtained by addition of the methylmethacrylate monomer are also insufficient. Japanese Patent Laid-open No. Hei 5-171022 discloses use of an unsaturated polyester resin and acrylic resin mixed in a kneader to obtain the same effects as described above. However, this patent also has disadvantages such as increased viscosity of the mixed compounds, and thus is not suitable for continuous molding.

In addition, U.S. Pat. No. 3,135,723 discloses a method of co-polymerizing α-methylstyrene with the acrylic resin so as to improve heat resistance of the acrylic resin. This method may be useful as a means for improving heat resistance of the acrylic resin itself, but presents problems associated with superficial appearance characteristics such as transparency and curing conditions when kneading with an inorganic filler and molding.

### SUMMARY OF THE INVENTION

Therefore, the present invention has been made in view of the above problems, and it is an object of the present invention to provide a resin composition comprising a styrene-methylmethacrylate copolymer having improved transparency due to reduction of refractive index difference between aluminum hydroxide and methylmethacrylate while maintaining excellent weatherability and thermal characteristics exhibited by conventional acrylic polymers.

It is another object of the present invention to provide an artificial marble prepared using the above-mentioned resin composition.

It is a further object of the present invention to provide a process for preparing an artificial marble.

### DETAILED DESCRIPTION OF THE INVENTION

In accordance with an aspect of the present invention, the above and other objects can be accomplished by the provision of a resin composition, comprising: 100 parts by weight of a styrene-methylmethacrylate resin solution containing a styrene-methylmethacrylate copolymer and at least one of styrene and methylmethacrylate; 100 to 200 parts by weight of an inorganic filler; and 0.5 to 10 parts by weight of a cross-linkable monomer.

In accordance with another aspect of the present invention, there is provided an artificial marble prepared using the above-mentioned resin composition.

In accordance with yet another aspect of the present invention, there is provided a process for preparing an artificial marble, comprising:

preparing a resin composition;

pouring the prepared resin composition into a continuous mold and curing it at a temperature of 20 to 150° C. for 30 min to 2 hours; and

cooling and cutting the resulting cured product, followed by surface polishing.

Now, the present invention will be described in more detail.

A resin composition in accordance with the present invention comprises 100 parts by weight of a styrene-methylmethacrylate resin solution containing a styrene-methylmethacrylate copolymer and at least one of styrene and methylmethacrylate; 100 to 200 parts by weight of an inorganic filler; and 0.5 to 10 parts by weight of a cross-linkable monomer.

In the present invention, the styrene-methylmethacrylate resin composition is prepared by placing a styrene-methylmethacrylate copolymer in styrene, methylmethacrylate or a mixture thereof and then dissolving them at a temperature of 40 to 60° C. Preferably, the content of the copolymer is within the range of 10 to 50 parts by weight, and the content of styrene, methylmethacrylate or a mixture thereof is within the range of 50 to 90 parts by weight, in 100 parts by weight of the styrene-methylmethacrylate resin solution. Where the content of the copolymer is less than 10 parts by weight, it is difficult to achieve desired effects such as an improved reaction rate and prevention of monomer volatilization. Where the content of the copolymer is greater than 50 parts by weight, it is undesirable in that undissolved materials may be present and viscosity may be excessively increased.

The styrene-methylmethacrylate copolymer is prepared from a methylmethacrylate monomer and styrene monomer in the presence of a polymerization catalyst by a conventional polymerization process. The styrene-methylmethacrylate copolymer has excellent weatherability and improved processability while maintaining a level of comparable gloss, transparency, surface hardness and low-absorptivity equal to those of a methylmethacrylate homopolymer. The content of styrene in 100 parts by weight of the styrene-methylmethacrylate copolymer in accordance with the present invention is preferably within the range of 20 to 80 parts by weight.

Preferably, the total content of styrene in 100 parts by weight of the styrene-methylmethacrylate resin solution in accordance with the present invention is within the range of 10 to 70 parts by weight. If the content of styrene is less than 10 parts by weight, transparency improving effects are not sufficient. In contrast, if the content of styrene is greater than 70 parts by weight, it is undesirable in that lowering of heat deflection temperature and weatherability become worse and the quality of the resulting product undesirably drops to a level of lower-grade unsaturated polyester based artificial marble.

The inorganic filler used in the present invention is selected from the group consisting of aluminum hydroxide, magnesium hydroxide, calcium aluminate and mixtures thereof and preferably has a refractive index of 1.57 to 1.62. This is because, when using a conventional methymethacrylate (refractive index 1.49) and polymers thereof alone, large refractive index difference between the methymethacrylate and filler (for example, aluminum hydroxide : 1.57-1.60) decreases transparency of the polymerized product. However, the present invention employs a styrene-methylmethacrylate copolymer in which the methylmethacrylate monomer was co-polymerized with a highly refractive styrene monomer (refractive index 1.59) in order to reduce the above-mentioned refractive index difference, thus capable of improving transparency of the resulting polymerized material.

Preferably, the inorganic filler has a surface treated with a silane based coupling agent, titanate based coupling agent or stearic acid, in order to improve dispersibility in the resin solution and mechanical strength of the product, and prevent precipitation thereof.

The preferred content of the inorganic filler is within the range of 100 to 200 parts by weight, relative to 100 parts by weight of the styrene-methylmethacrylate resin solution. Where the content of the inorganic filler is less than 100 parts by weight, the resulting artificial marble undergoes weakening of flame retardancy, loss of color tone, sharply decreased strength and deterioration of texture. Conversely, where the content of the inorganic filler exceeds 200 parts by weight, this may cause a lowering of workability such as increased viscosity and reduced curing rate, and a lowering of mechanical characteristics of the artificial marble.

In addition, the particle size of the inorganic filler is preferably within the range of 5 to 100 μm. Where the particle size of the inorganic filler is smaller than 5 μm, the resulting artificial marble may exhibit poor light-transmittance performance. In contrast, where the particle size of the inorganic filler is larger than 100 μm, physical properties of the artificial marble may be deteriorated.

The cross-linkable monomer utilized in the present invention is a multifunctional acrylic monomer having double bond(s) in the molecular structure thereof. For example, mention may be made of ethylene glycol dimethacrylate, diethylene glycol dimethacrylate, triethylene glycol dimethacrylate, tetraethylene glycol dimethacrylate, 1,6-hexane diol dimethacrylate, polybutylene glycol dimethacrylate, trimethylol propane trimethacrylate and neopentyl glycol dimethacrylate and any combination thereof. Among these, ethylene glycol dimethacrylate is particularly preferred. The content of the cross-linkable monomer is preferably within the range of from 0.5 to 10 parts by weight, relative to 100 parts by weight of the styrene-methylmethacrylate resin solution. If the content of the cross-linkable monomer is less than 0.5 parts by weight, thermal properties and strength of the resulting polymerized material are significantly deteriorated. In contrast, if the content of the cross-linkable monomer is greater than 10 parts by weight, it is undesirable in that excessive heat generation in a polymerization process tends to cause cracking.

In the present invention, a polymerization initiator is used to perform polymerization and curing of the styrene-methylmethacrylate resin composition. The polymerization initiator is an organic peroxide and may be selected from the group consisting of diacyl peroxides such as benzoyl peroxide and dicumyl peroxide, hydroperoxides such as butyl hydroperoxide and cumyl hydroperoxide, t-butyl peroxy maleic acid, t-butyl hydroperoxide, acetyl peroxide, lauroyl peroxide, azobisisobutyronitrile and azobisdimethylvaleronitrile and any combination thereof. In addition, polymerization and curing can be performed at room temperature using a mixture of the peroxide and amine or sulfonic acid, or a mixture of the peroxide and a cobalt compound. The content of the polymerization initiator is preferably within the range of 0.1 to 5 parts by weight, relative to 100 parts by weight of the styrene-methylmethacrylate resin solution, and is typically used in combination with a polymerization promoter. Where the content of the polymerization initiator is less than 0.1 parts by weight, the curing rate is slow and curing is not sufficiently progressed. In contrast, where the content of the polymerization initiator is greater than 5 parts by weight, the curing rate is retarded and partial un-curing may occur.

A chain transfer agent serving to control molecular weight is employed in the present invention. The chain transfer agent is preferably a mercaptan compound selected from normal dodecyl mercaptan, tertiary dodecyl mercaptan, benzyl mercaptan and trimethylbenzyl mercaptan. The content of the chain transfer agent is preferably within the range of 0.1 to 5 parts by weight, relative to 100 parts by weight of the styrene-methylmethacrylate resin solution. If the content of the chain transfer agent is less than 0.1 parts by weight, there is no substantial effect. In contrast, where the content of the chain transfer agent is greater than 5 parts by weight, the curing rate is significantly decreased and complete curing cannot be achieved.

Additionally, in accordance with the present invention, in order to obtain surface morphology similar to natural marbles, the pre-molded acrylic, unsaturated polyester based or epoxy based artificial marble is crushed into a predetermined size and the ground material, in the form of granules, thus obtained is mixed and polymerized with the above-mentioned composition followed by molding. The resulting molded article surface is then polished using sand paper or other processes known in the art, in order to provide a smooth surface and gloss. If surface processing is not performed after molding, desired pattern effects cannot be achieved and the surface of the product is uneven. Therefore, it is preferred to perform surface processing.

If the content of the ground material is greater than 200 parts by weight, relative to 100 parts by weight of the styrene-methylmethacrylate resin solution, it is undesirable in that changes in viscosity with respect to the passage of time become severe and the strength of the cured product is significantly decreased.

The size of the ground material is preferably within the range of 100 to 3.5 mesh. Where the size of the ground material is smaller than 100 mesh, changes in viscosity become severe with respect to the passage of time, leading to poor workability. In contrast, where the size of the ground material is larger than 3.5 mesh, this may results in problems such as highly frequent bubbling and poor visual appearance due to migration of the ground material upon curing, and deterioration of mechanical strength of the cured product.

In addition, the resin composition may further comprise commonly known additive ingredients for the artificial marble, for example, at least one additive selected from the group consisting of: a silicone- or non-silicone based antifoaming agent; a silane based, acidic or titanate based coupling agent, containing trimethoxysilane as a main ingredient; an organic or inorganic pigment or dye; phenyl salicylate-, benzophenone-, benzotriazole-, nickel derivative- or radical scavenger-based UV-light absorber; halogen-, phosphorus- or inorganic metal-based flame retardant; a stearic acid- or silicone-based release agent; a catechol- or hydroquinone-based polymerization inhibitor; and a phenol-, amine-, quinone-, sulfur- or phosphorus-based antioxidant and thermal stabilizer The artificial marble in accordance with the present invention is prepared as follows.

Firstly, the styrene-methylmethacrylate copolymer is placed in styrene, methylmethacrylate or a mixture thereof as a solvent and dissolved at a temperature of 40 to 60° C. to prepare the styrene-methylmethacrylate resin solution. Then, the inorganic filler, cross-linkable monomer, polymerization initiator, chain transfer agent, ground material, and other additives are added to the resulting resin solution and the mixture is stirred well to prepare a resin composition.

In preparing the styrene-methylmethacrylate resin solution, only a part of the styrene, methylmethacrylate or a mixture thereof may be used to dissolve the copolymer so as to prepare the syrup, and then the remaining parts thereof may be mixed with the resulting syrup in order to control viscosity and styrene content.

Next, the prepared resin composition is defoamed and continuously fed to a mold. As the mold continuously moves, curing is progressed (so-called, continuous casting).

In this connection, curing conditions for the continuous molding are preferably a temperature of 20 to 150° C. and duration of 30 min to 2 hours. If the curing temperature is lower than 20° C., it is difficult to smoothly progress the curing process. Whereas, if the curing temperature is higher than 150° C., this may undesirably cause excessive volatilization of the monomer in the course of the polymerization process, and deformation and cracking of the polymerization product. In addition, where the curing time is shorter than 30 min, the curing process may require excessive energy supply and thus may exhibit the same problems as when the temperature is greater than 150° C. Conversely, where the curing time is longer than 2 hours, it is undesirable in that the inorganic filler and particulate ground material are settled and productivity is lowered.

Thereafter, the cured product is cooled and cut into a specified size. This is followed by surface polishing in order to accentuate effects of the added ground material.

### EXAMPLES

Now, the present invention will be described in more detail with reference to the following Examples. These examples are provided only for illustrating the present invention and should not be construed as limiting the scope and sprit of the present invention.

### Example 1

To 100 parts by weight of the styrene-methylmethacrylate resin solution, which was prepared by dissolving 25 parts by weight of a styrene-methylmethacrylate copolymer (80% by weight of styrene content, NAS 21, available from Nova Chemical, USA) in methylmethacrylate, were added 180 parts by weight of aluminum hydroxide, 3 parts by weight of diethylene glycol dimethacrylate, 1.0 part by weight of benzoyl peroxide (BPO), 0.1 parts by weight of normal dodecyl mercaptan, 0.5 parts by weight of BYK 555 (BYK-Chemie, Germany) as an antifoaming agent, 1 part by weight of BYK 900 (BYK-Chemie, Germany) as a coupling agent, 0.5 parts by weight of Hisorp-P (LG Chem., Ltd., Seoul, Korea) as a UV-light stabilizer (absorber) and 150 parts by weight of ground material, and stirred well. The resulting mixture was poured into a continuous mold and cured at a temperature of 20 to 150° C. to prepare an artificial marble in accordance with the present invention.

### Example 2

An artificial marble was prepared following the same procedure as in Example 1, except that MS 600 (40% by weight of styrene content, Nippon Steel Chemical Co., Ltd., Japan), as a styrene-methylmethacrylate copolymer, was used to prepare a styrene-methylmethacrylate resin solution.

### Example 3

An artificial marble was prepared following the same procedure as in Example 1, except that, as a styrene-methylmethacrylate copolymer, MS 600 (40% by weight styrene content) was dissolved in a mixture of methylmethacrylate and styrene to prepare a styrene-methylmethacrylate resin solution.

### Example 4

An artificial marble was prepared following the same procedure as in Example 1, except that 40 parts by weight of a styrene-methylmethacrylate copolymer was dissolved in a mixture of methylmethacrylate and styrene to prepare a styrene-methylmethacrylate resin solution.

### Example 5

An artificial marble was prepared following the same procedure as in Example 1, except that a styrene-methylmethacrylate resin solution was prepared by mixing 50 parts by weight of a styrene monomer with 50 parts by weight of a styrene-methylmethacrylate syrup, which was prepared by dissolving 25 parts by weight of a styrene-methylmethacrylate copolymer (80% by weight styrene content, NAS 21, available from Nova Chemical, USA) in a methylmethacrylate monomer.

### Example 6

An artificial marble was prepared following the same procedure as in Example 1, except that, as a styrene-methylmethacrylate copolymer, MS 600 (40% by weight styrene content) was dissolved in a mixture of a methylmethacrylate monomer and a styrene monomer to prepare a styrene-methylmethacrylate resin solution, and 6 parts by weight of diethylene glycol dimethacrylate, 2.0 parts by weight of a benzoyl peroxide (BPO) and 0.5 parts by weight of a heat resistant antioxidant (B-561, Ciba Specialty Chemicals, USA) were further added thereto.

### Comparative Example 1

An artificial marble was prepared following the same procedure as in Example 1, except that a methylmethacrylate resin solution was prepared using a methylmethacrylate polymer instead of a styrene-methylmethacrylate copolymer.

### Comparative Example 2

An artificial marble was prepared following the same procedure as in Example 1, except that 85.7 parts by weight of an unsaturated polyester resin (M-900, Sewon Chemical Co., Ltd., Seoul, Korea) was dissolved in 14.3 parts by weight of a methylmethacrylate to prepare a resin solution and 0.3 parts by weight of normal dodecyl mercaptan was added thereto.

### Comparative Example 3

An artificial marble was prepared following the same procedure as in Example 1, except that a resin solution was prepared by mixing 20 parts by weight of a styrene monomer with 80 parts by weight of a methylmethacrylate syrup, which was prepared by dissolving 25 parts by weight of a methylmethacrylate polymer in methylmethacrylate.

### Comparative Example 4

An artificial marble was prepared following the same procedure as in Example 1, except that a resin solution was prepared by mixing 40 parts by weight of a styrene monomer with 60 parts by weight of a methylmethacrylate syrup, which was prepared by dissolving 25 parts by weight of a methylmethacrylate polymer in methylmethacrylate.

### Comparative Example 5

An artificial marble was prepared following the same procedure as in Example 1, except that a styrene-methylmethacrylate resin solution was prepared by dissolving 25 parts by weight of a styrene-methylmethacrylate copolymer (40% by weight styrene content, MS 600, Nippon Steel Chemical Co., Ltd., Japan) in styrene, instead of methylmethacrylate.

### Comparative Example 6

An artificial marble was prepared following the same procedure as in Example 1, except that a styrene-methylmethacrylate resin solution was prepared by dissolving 25 parts by weight of a methylmethacrylate polymer in a mixture of methylmethacrylate and styrene.

Transparency, thermal discoloration resistance, weatherability and heat deflection temperature of artificial marbles prepared in Examples 1 through 6 and Comparative Examples 1 through 6 were evaluated as follows. Results thus obtained are shown and compared in Table 1.

Evaluation Method

(1) Transparency

This was measured by removing pigments and ground materials which might affect transparency of artificial marbles, from compositions of the above-mentioned Examples and Comparative Examples, to prepare the cured products having a thickness of 2 mm, followed by determination of transparency using a Haze meter (Murakami Color Research Laboratory, Japan).

(2) Thermal discoloration resistance (ΔE)

A specimen of an artificial marble was allowed to stand at a temperature of 170° C. for 1 hour and thermal discoloration resistance was measured using a color difference meter.

(3) Weatherability (ΔE)

Accelerated Weathering Test was performed using a QUV tester according to ASTM G-53 and then weatherability was measured using a color difference meter.

(4) Heat deflection temperature (° C.)

This was measured according to ASTM D 648

TABLE 1

| | | | SM⁴⁾ | | | | |
|---|---|---|---|---|---|---|---|
| | | | content in | | | | Heat |
| | | | resin | | Thermal | | deflection |
| | | | solution | Transpar- | discoloration | Weather- | tempera- |
| | | | (parts by | ency | resistance | ability | ture |
| | Polymer | Solvent | weight) | (%) | (ΔE) | (ΔE) | (° C.) |
| Ex. 1 | S-M | MMA³⁾ | 20 | 33 | 0.23 | 2.3 | 105.6 |
| | Copolymer¹⁾ | | | | | | |
| Ex. 2 | S-M | MMA | 10 | 30 | 0.18 | 1.98 | 106.0 |
| | Copolymer | | | | | | |
| Ex. 3 | S-M | MMA, SM | 40 | 45 | 0.67 | 2.5 | 102.0 |
| | Copolymer | | | | | | |
| Ex. 4 | S-M | MMA, SM | 60 | 60 | 0.98 | 3.0 | 98.3 |
| | Copolymer | | | | | | |
| Ex. 5 | S-M | MMA, SM | 70 | 65 | 1.38 | 3.7 | 94.5 |
| | Copolymer | | | | | | |
| Ex. 6 | S-M | MMA, SM | 40 | 45 | 0.47 | 1.77 | 102.3 |
| | Copolymer | | | | | | |
| Comp. | PMMA²⁾ | MMA | 0 | 18 | 0.17 | 1.8 | 106 |
| Ex. 1 | | | | | | | |
| Comp. | Polyester | MMA | 40 | 48 | 4.68 | 7.3 | 104 |
| Ex. 2 | | | | | | | |
| Comp. | PMMA | MMA, SM | 20 | 25 | 0.41 | 2.4 | 104.7 |
| Ex. 3 | | | | | | | |
| Comp. | PMMA | MMA, SM | 40 | 35 | 0.75 | 3.9 | 101.9 |
| Ex. 4 | | | | | | | |
| Comp. | S-M | SM | 85 | 70 | 2.46 | 5.5 | 86.0 |
| Ex. 5 | Copolymer | | | | | | |
| Comp. | PMMA | MMA, SM | 20 | 26 | 0.45 | 2.5 | 103.5 |
| Ex. 6 | | | | | | | |

Note:
¹⁾S-M Copolymer represents a styrene-methylmethacrylate copolymer.
²⁾PMMA represents a methylmethacrylate polymer.
³⁾MMA represents methylmethacrylate.
⁴⁾SM represents styrene.

As can be seen from Table 1, artificial marbles prepared in Examples 1 through 6 exhibited remarkably improved transparency compared to Comparative Example 1 in which a conventional methylmethacrylate polymer was used alone. However, as shown in Comparative Example 5, when the content of styrene (SM) in the total resin solution was 85 parts by weight, thermal discoloration resistance and weatherability were significantly decreased and heat deflection temperature was also lowered.

In addition, at the same content of styrene in the resin solution, use of the styrene-methylmethacrylate copolymer (S-M copolymer) provided relatively improved thermal discoloration resistance, weatherability and heat deflection temperature characteristics, compared to when such a copolymer was not used.

The resin composition comprising the styrene-methylmethacrylate copolymer in accordance with the present invention can provide an artificial marble having improved transparency due to reduction of refractive index difference between aluminum hydroxide and methylmethacrylate while maintaining excellent weatherability and thermal characteristics possessed by a conventional acrylic polymer.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A resin composition, comprising:
100 parts by weight of a styrene-methylmethacrylate resin solution containing a styrene-methylmethacrylate copolymer and at least one of styrene and methylmethacrylate;
100 to 200 parts by weight of an inorganic filler; and
0.5 to 10 parts by weight of a cross-linkable monomer.

2. The composition as set forth in claim 1, wherein the amount of the styrene-methylmethacrylate copolymer is 10 to 50 parts by weight, and the amount of at least one of styrene and methylmethacrylate is 50 to 90 parts by weight, relative to 100 parts by weight of the styrene-methylmethacrylate resin solution.

3. The composition as set forth in claim 1, wherein the content of styrene in 100 parts by weight of the styrene-methylmethacrylate resin solution is within the range of 10 to 70 parts by weight.

4. The composition as set forth in claim 1, wherein the inorganic filler is selected from the group consisting of aluminum hydroxide, magnesium hydroxide, calcium aluminate, and mixtures thereof.

5. The composition as set forth in claim 1, wherein the inorganic filler is surface-treated with a silane based coupling agent, titanate based coupling agent or stearic acid.

6. The composition as set forth in claim 1, wherein the particle size of the inorganic filler is within the range of 5 to 100 μm.

7. The composition as set forth in claim 1, wherein the cross-linkable monomer is selected from the group consisting of ethylene glycol dimethacrylate, diethylene glycol dimethacrylate, triethylene glycol dimethacrylate, tetraethylene glycol dimethacrylate, 1,6-hexane diol dimethacrylate, polybutylene glycol dimethacrylate, trimethylol propane trimethacrylate, neopentyl glycol dimethacrylate, and mixtures thereof.

8. The composition as set forth in claim 1, further comprising:
0.1 to 5 parts by weight of a polymerization initiator; and
0.1 to 5 parts by weight of a chain transfer agent.

9. The composition as set forth in claim 8, wherein the polymerization initiator is selected from the group consisting of benzoyl peroxide, dicumyl peroxide, butyl hydroperoxide, cumyl hydroperoxide, t-butyl peroxy maleic acid, t-butyl hydroperoxide, acetyl peroxide, lauroyl peroxide, azobisisobutyronitrile, azobisdimethylvaleronitrile, a mixture of peroxide and amine or sulfonic acid, a mixture of peroxide and a cobalt compound, and mixtures thereof.

10. The composition as set forth in claim 8, wherein the chain transfer agent is selected from normal dodecyl mercaptan, tertiary dodecyl mercaptan, benzyl mercaptan and trimethylbenzyl mercaptan.

11. The composition as set forth in claim 1, further comprising at least one additive selected from the group consisting of ground material, an antifoaming agent, a coupling agent, an organic or inorganic pigment or dye, a UV-light absorber, a flame retardant, a release agent, a polymerization inhibitor, a thermal stabilizer and an antioxidant.

12. The composition as set forth in claim 11, wherein the ground material is in the form of granules prepared by crushing acrylic, unsaturated polyester based or epoxy based artificial marble into a predetermined size.

13. The composition as set forth in claim 11, wherein the size of the ground material is within the range of 100 to 3.5 mesh.

14. An artificial marble prepared using a resin composition according to claim 1.

15. A process for preparing an artificial marble, which comprises:
preparing a resin composition according to claim 1;
pouring the resin composition into a continuous mold and curing it at a temperature of 20 to 150° C. for 30 minutes to 2 hours; and
cooling and cutting the cured product, followed by surface polishing.
